(19) United States
(12) Patent Application Publication
(10) Pub. No.: US 2010/0076984 A1
(43) Pub. Date: Mar. 25, 2010

(54) SYSTEM AND METHOD FOR QUERY EXPANSION USING TOOLTIPS

(76) Inventors: Alkis Papadopoullos, Outremont (CA); Claude Vogel, Key West, FL (US); Matthias Howell, Montreal West (CA)

Correspondence Address: K&L Gates LLP, STATE STREET FINANCIAL CENTER, One Lincoln Street, BOSTON, MA, 02111-2950, US

(21) Appl. No.: 12/412,316

(22) Filed: Mar. 26, 2009

Related U.S. Application Data
(60) Provisional application No. 61/064,816, filed on Mar. 27, 2008.

(51) Int. Cl. G06F 17/30; G06F 3/048

(52) U.S. Cl. 707/749; 707/772; 715/784; 707/E17.014; 707/E17.008

(57) ABSTRACT

A system and method for query expansion allows the refinement and expansion of a keyword query search by combining a key concept with semantically related concepts proposed by the system and associated with that key concept. The semantically related concepts may be grouped together in a cluster, which is then presented to the user in the form of a tooltip. Once a semantically related concept is selected from the cluster, a new search is launched. This new search may use as query terms the combination of at least part of the key concept and the selected semantically related concept to thereby expand the original search.

### FIELD

The present invention generally relates to searches of documents and information conducted on the World Wide Web (Web) or other networks. More specifically, the present invention is concerned with a system and method for query expansion using tooltips.

### BACKGROUND

With the advent of the Internet and the Web, an incredibly large amount of information is available to each user connected to Internet. However, a drawback of this huge available amount of information is that it is often difficult and time consuming to find the desired information, since there is so much to go through. Indeed, each page on the Web is linked to so many other pages as to form an interconnected web.

Search engines have been developed for conducting searches on the Web. For example, the search engines are used to locate texts, images or videos stored on personal computers, corporate intranets and other networks such as the World Wide Web. When using a search engine, the user first enters a keyword query, consisting of at least one keyword, in a query box usually provided by the search engine. Then a button is pressed in order to run a search about their query. The search engine returns a series of search result items, for the users to view. The user can click on any of the search result items that appears interesting to them to get access to the relate document. However, once they have clicked on one particular result item to examine it in more detail, the only way to search about a key concept that they had come across while going through the selected search result item is to memorize or copy the key concept, then return to the search engine and re-enter a new query at the query box using the memorized key concept. Therefore, it can get quite annoying when the user wishes to further explore a large number of interesting terms and key concepts that they have come across during searches.

Also, because of this immense amount of available information on networks such as the Web, the terms chosen to be included in the search query are important so as to be able to obtain proper search results. For example, if the query terms contain an error, then the search results provided by the search engines may be concerned with a different topic than the one intended to by the user. Thus, the search engines have developed some mechanisms to help the users with their query. For example, functions such as “did you mean . . . ” propose alternative terms or provide a chance to correct the spelling of the keywords entered by the users or even change the focus of the user's query. However, these mechanisms do not allow for expanding a user's query.

Therefore, there is a need for overcoming the above-addressed issues and for improving the search engines. Accordingly, there is provided a system and method for query expansion using tooltips.

### BRIEF DESCRIPTION OF THE DRAWINGS

In the appended drawings:

FIG. 1 is a schematic framework for a query expansion system according to a non-restrictive illustrative embodiment of the present invention;

FIG. 2 shows an example of keywords highlighted in a document used by the system for query expansion;

FIG. 3 shows an example of a cluster of semantically related concepts associated with a highlighted keyword;

FIGS. 4A-4D illustrate different sizes of a tooltip used in the system for query expansion; and

FIG. 5 is a flow chart of a method for query expansion.

### DETAILED DESCRIPTION

In accordance with an illustrative embodiment, there is provided a method for expanding a keyword query search returning a set of documents related to the keyword query, the search expanding method comprising:
characterizing one keyword in the returned set of documents;
for each characterized keyword, proposing a cluster of concepts semantically related thereto;
upon selection of a semantically related concept in the cluster associated to one keyword, launching a new search using a query containing at least the selected semantically related concept and at least one keyword thereby expanding the original keyword query search.

In accordance with an illustrative embodiment, there is provided a system for expanding a keyword query search returning a set of documents related to the keyboard query, the search expanding system comprising:
means for characterizing one keyword in the returned set of documents;
means for proposing, for each characterized keyword, a cluster of concepts semantically related thereto;
means for selecting a semantically related concept in the cluster, associated to one keyword; and
means for launching a new search using a query containing at least the selected semantically related concept and at least one keyword as the query, thereby expanding the original keyboard entry search.

In accordance with another illustrative embodiment, there is provided a system for expanding a keyword query search returning a set of documents related to the keyword entry, the search expanding system comprising:
a processor so configured as to characterize one keyword in the returned set of documents;
a display so configured as to display of a cluster of concepts semantically related to each characterized keyword;
a pointer so configured as to select a semantically related concept in the cluster; and
a query server for launching a new search with a query including at least the selected semantically related concept and at least one keyword, thereby expanding the original keyword query search.

The use of the word “a” or “an” when used in conjunction with the term “comprising” in the claims and/or the specification may mean “one”, but it is also consistent with the meaning of “one or more”, “at least one”, and “one or more than one”. Similarly, the word “another” may mean at least a second or more.

As used in this specification and claim(s), the words “comprising” (and any form of comprising, such as “comprise” and “comprises”), “having” (and any form of having, such as “have” and “has”), “including” (and any form of including, such as “include” and “includes”) or “containing” (and any form of containing, such as “contain” and “contains”), are inclusive or open-ended and do not exclude additional, unrecited elements or process steps.

The term “about” is used to indicate that a value includes an inherent variation of error for the device or the method being employed to determine the value.

It is to be noted that the expression “keyword query” is to be construed herein and in the appended claims as any type of text query that can be supplied to a search engine. A keyword query may thus be a single keyword, a plurality of keywords, a search phrase, a name, etc.

Other objects, advantages and features of the present invention will become more apparent upon reading of the following non- restrictive description of illustrative embodiments thereof, given by way of example only with reference to the accompanying drawings.

Generally stated, the system and method for query expansion according to a non-restrictive illustrative embodiment of the present invention allows to refine or expand a search by combining a key concept, that came across to a user, with semantically related concepts proposed by the system and associated with that key concept. In an illustrated embodiment, the semantically related concepts are grouped together in a cluster, which is then presented to the user in the form of a tooltip. Once a semantically related concept is selected from the cluster, a new search is launched. This new search may use as query terms the combination of at least part of the key concept and the selected semantically related concept to thereby expand the original search. Generally, a tooltip is used in interactive graphical browsers to provide additional information about a term pointed by or hovered over with the cursor of a mouse. The additional information regarding the item being hovered over is usually presented inside a small box.

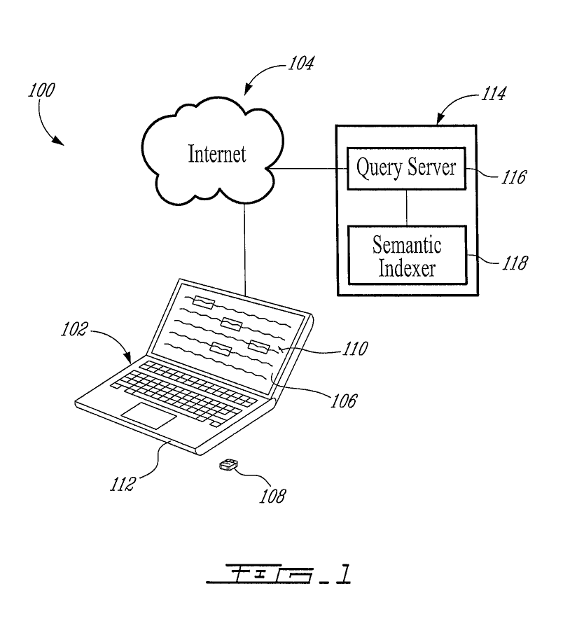

Now turning to FIG. 1 of the appended drawings, an example of framework 100 defining the system for query expansion according to a non-restrictive illustrative embodiment of the present invention will be described.

The framework 100 generally comprises a computer 102 connected to Internet 104 or any other types of networks and a server 114 connected to Internet 104 as well.

More specifically, the computer 102 has a conventional access to the Internet 104 through an ISP (Internet Service Provider) or through any other private networks. Conventionally, the computer 102 has a screen 106 which can display objects such as texts, images or videos requested by the user, for example. Furthermore, a mouse 108 is connected to the computer 102, allowing the user to interact with the objects displayed on the screen 106. The mouse generates a cursor 110 on the screen 106 so that the user can point at some specific objects. Other devices, such as a keyboard 112 and/or a trackball (not shown), can be also used for interaction with the different objects shown on the screen 106. Also, the computer 102 may comprise many applications, such as a graphical browser to surf the Web.

The computer 102 can access a server 114, which is also connected to Internet 104. The computer 102 can use the search engines provided by the server 114 to conduct searches, for example. More specifically, the server 114 includes a query server 116 and a semantic indexer 118 in communication with each other.

The semantic indexer 118 indexes and classifies a set of text objects in a document or a collection of documents into categories of different concepts, the concepts being represented by keywords, which are generally highlighted in the texts presented to the users, for example. To do so, first the text objects in a collection of documents are typically parsed and tokenized. Then generic precursors representing head concepts contained in the parsed text objects are extracted. Those generic precursors are matched and linked to ontologies and topic-specific taxonomies. Therefore, for each precursor, a cluster of semantically related concepts can be extracted and attached thereto. Furthermore, the keywords corresponding to these precursors can be highlighted in the text document presented to the user so that the user can easily identify the key concepts contained in the document.

It should be noted that other methods of indexing and classifying and indexing systems can be used to generate a cluster of semantically related concepts, and which fall within the scope and nature of the present invention. For example, any indexer, other than the semantic indexer 118, which can create links between different concepts and elements, can be used. The links can be determined through cultural, linguistic, semantic or any other kinds of relations.

Generally stated, when a user wishes to conduct a search through a search engine, the user submits a keyword query containing at least one keyword to the query server 116. Upon receiving the user's query, the query server 116 analyzes the user's query through parsing and then extracts the precursors contained in the query. One or several documents containing the keywords of the query are returned to the user as the results of the search through the query server 116.

Those returned documents have been processed by the semantic indexer 118 so that the keywords corresponding to the precursors contained in these documents are highlighted. The highlighting process can be done by the processor of the computer 102, for example. Furthermore, the semantic indexer 118 provides for each keyword a cluster of concepts semantically related to each of the keywords contained in the documents. The clusters of semantically related concepts are presented to the users through the display 106. More specifically, the clusters of semantically related concepts can be accessed by the user through the use of a tooltip, for example.

Alternatively, it is possible to design a system where only the keywords, used by the user for entering an original query for example, are highlighted in the returned documents. In this case, only those keywords are processed in the semantic indexer 118, which then provides a cluster of semantically related concepts. Also, when the user clicks, using the mouse 108 or a pointer represented by the cursor 110, on any of the semantically related concepts in order to further the query, a new query that comprises all the keywords entered in the original query plus the selected semantically related concept is launched.

It should be noted that other ways, besides highlighting, for displaying the key concepts in a document are available. In the same manner, other ways for presenting the clusters, besides tooltips, to the users are also available and fall within the scope and nature of the present invention.

Other examples for displaying the key concepts include underlining, changing the style, police, font, color, etc. of the keywords corresponding to the key concepts, or drawing an icon near the keywords, etc.

Other examples for presenting the clusters to the user include using combo-boxes, drop-down menus, or popup windows.

Still referring to FIG. 1, more specifically, the system for expanding a query submitted by a user uses the cursor 110 which can be used to hover over the highlighted keywords in the text document.

The system also includes the cluster of semantically related concepts attached to each of the highlighted keywords. The cluster of semantically related concepts is presented to the user in the form of a tooltip, as described above.

The query server 116 launches a refined search when the user clicks on one of the proposed semantically related concepts listed in the tooltip associated with a keyword. As mentioned hereinabove, the newly launched search uses the combination of the original keywords used in the original search and the semantically related concept clicked by the user. Alternatively, the newly launched search can use the combination of the highlighted keyword to which the proposed semantically related concepts are associated and the semantically related concept clicked by the user. By so doing, it is therefore possible to expand and refine the original search or query.

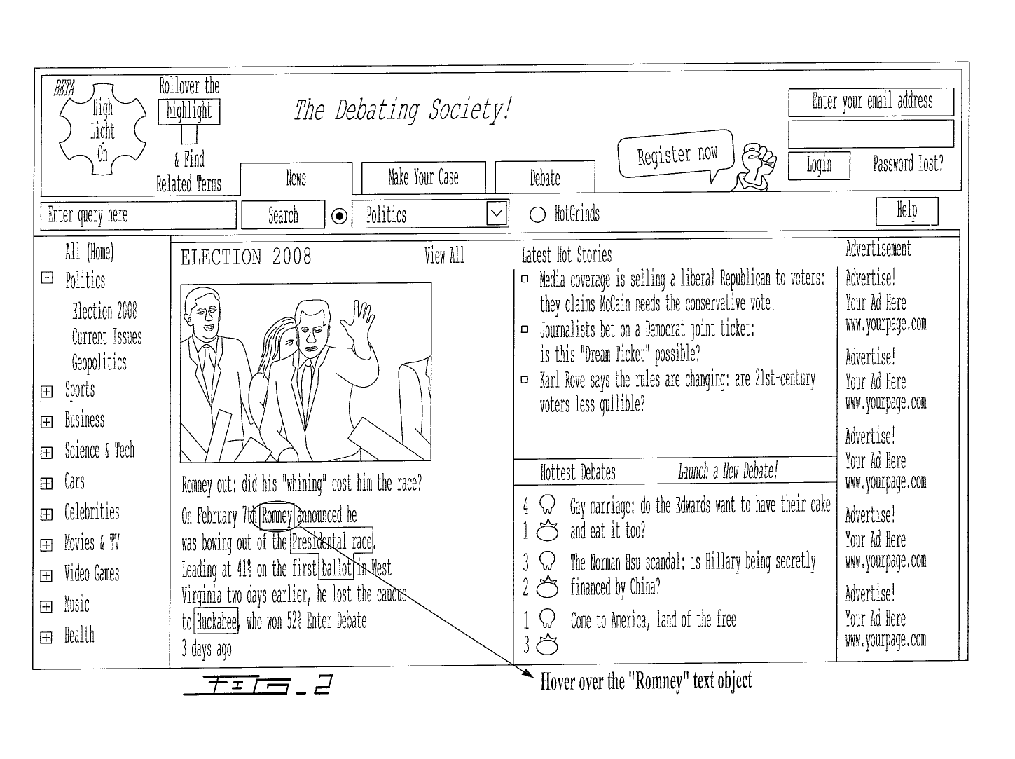

For example, as illustrated in FIG. 2, in a document returned by a first search, some terms are highlighted, corresponding to the keywords associated with the respective key concepts contained in the document. For example, the terms “Romney” and “Presidential race” are highlighted.

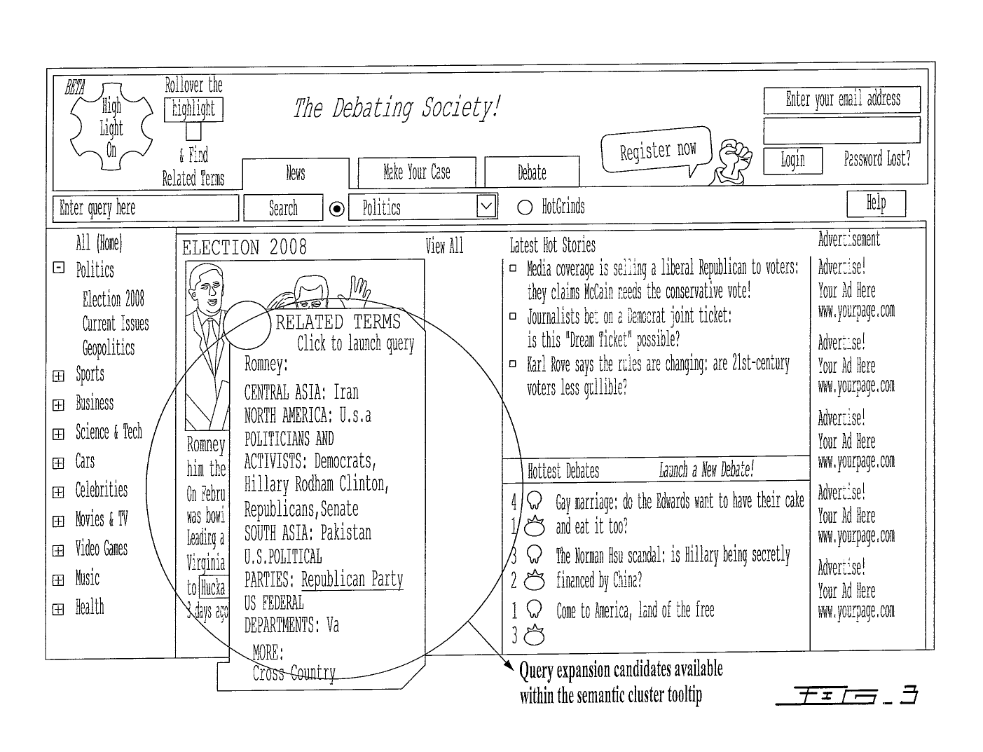

In FIG. 3, a cluster of semantically related concepts is shown in a form of a tooltip, associated with the highlighted term “Romney”, when the cursor hovers over that term. It is then possible for the user to click on any of the displayed items inside the tooltip to thereby launch a new search.

Furthermore, when required, the tooltip presented to the user comprises an item entitled “MORE”. By clicking on that item, additional semantically related concepts are provided to the user for query expansion.

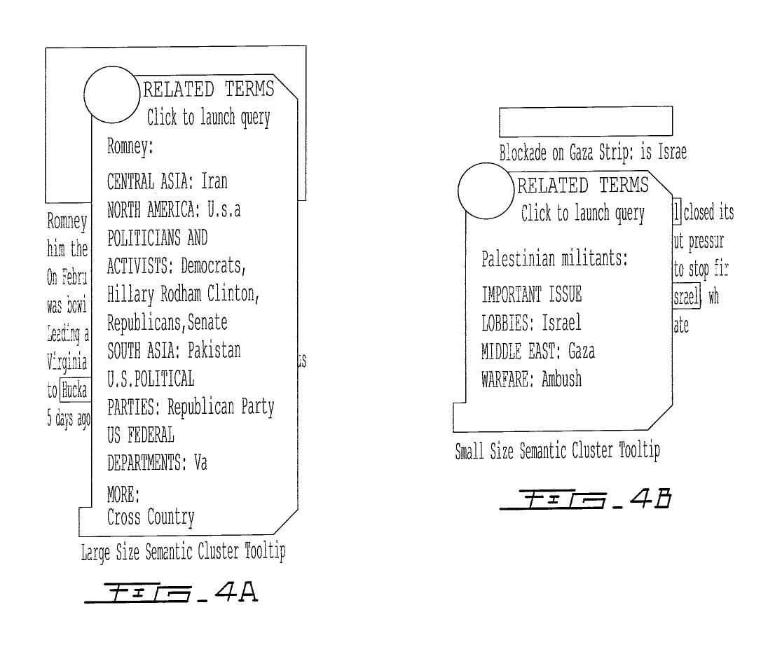

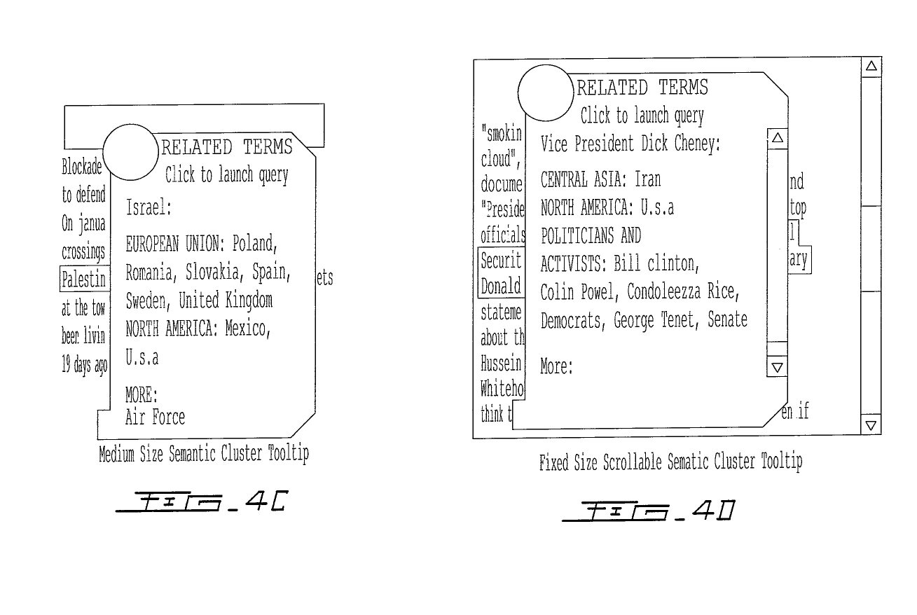

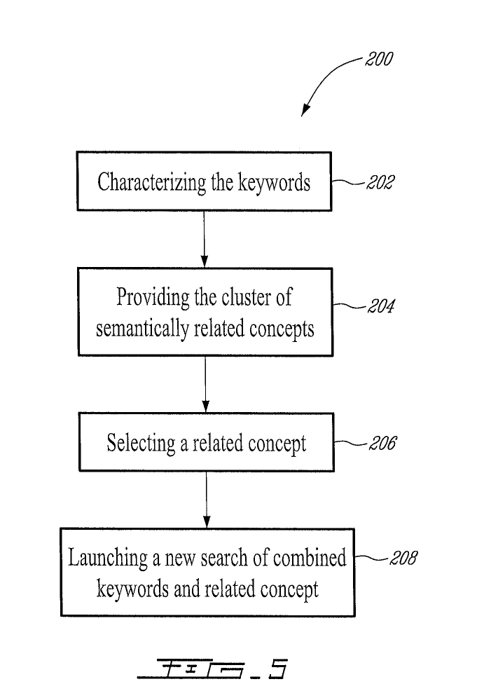

Furthermore, as shown in FIG. 4, the tooltip can have different sizes, which take into account the relative position of the keyword being pointed at in the document, the number of semantically related concepts attached to that keyword, etc. For example, in FIG. 4A, a large size tooltip is illustrated when the cursor hovers over a highlighted keyword, i.e. a large number of semantically related concepts are associated with that highlighted keyword. In FIG. 4B, an example of a small size tooltip is shown and in FIG. 4C, an example of a medium size tooltip is illustrated. In addition, the position of the cluster can be also adjusted in order to be centered both horizontally and vertically within the screen 106 for optimal presentation purposes.

Further still, a fixed size but scrollable tooltip can also be defined, as shown in FIG. 4D. If the document containing the highlighted keywords defines a scrollable area, then the tooltip corresponding to the highlighted keywords can also define a scrollable area.

Now turning to FIG. 5, a method 200 for performing an expanded query will be described.

Generally, through a preliminary and simple search, corresponding to an original search query, a user views a document returned by the search engine provided by the query server 114, for example.

In operation 202, the keywords associated to the key concepts contained in the document returned by the search engine and viewed by the user are characterized by being highlighted. As explained hereinabove, highlighting the keywords associated with the key concepts can be performed through the semantic indexer 118 or within the computer 102. As mentioned hereinabove, other methods of characterization, such as underlining, can be used.

It should be noted that there are other ways of characterizing the terms of a document that represent the key concepts contained in that document. Such term characterization allows attracting the user's attention so that the user can use those terms for expanding an original query.

Next, in operation 204, for each highlighted keyword, a cluster of related semantic concepts is provided, through the semantic indexer 118 for example. The user can just hover over the highlighted keywords to see the cluster of semantically related concepts appearing in a tooltip, whose size can be adjusted for optimal presentation purposes.

Then in operation 206, the user can click on an item in the cluster of semantically related concepts provided by the tooltip. Each item in the cluster corresponds to a hyperlink, linked to the semantic indexer 118 for example.

Once the user clicks on a particular item in the tooltip, a new search is launched in operation 208. The query for this new search comprises the combination of the highlighted keyword with the related semantic concept selected by the user, to thereby expand and refine the query search.

Alternatively, the newly launched query can comprise all the original keywords entered in a first query plus the selected semantically related concept provided by the tooltip.

It is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the present invention has been described hereinabove by way of illustrative embodiments thereof, it can be modified, without departing from the spirit, scope and nature of the subject invention as defined in the appended claims.

What is claimed is:

1. A method for expanding a keyword query search returning a set of documents related to the keyword query, the search expanding method comprising:
characterizing one keyword in the returned set of documents;
for each characterized keyword, proposing a cluster of concepts semantically related thereto;
upon selection of a semantically related concept in the cluster associated to one keyword, launching a new search using a query containing at least the selected semantically related concept and at least one keyword thereby expanding the original keyword query search.

2. The search expanding method as recited in claim 1 further comprising processing the set of documents related to the query to index and classifying the set of documents into categories of different concepts.

3. The search expanding method as recited in claim 2, wherein the indexing and the classifying the set of documents include:
parsing and tokenizing text objects contained in the set of documents;
extracting precursors from the parsed text objects in the set of documents, the precursors corresponding to the keywords; and
linking the extracted precursors to corresponding topic-specific taxonomies and ontologies so as to determine concepts semantically related to the extracted precursors, the semantically related concepts forming the cluster.

4. The search expanding method as recited in claim 1, wherein characterizing one keyword includes highlighting the keyword in the returned set of documents.

5. The search expanding method as recited in claim 4, wherein characterizing one keyword includes displaying the plurality of keywords in a different format, in the returned set of documents.

6. The search expanding method as recited in claim 1, wherein proposing the cluster of concepts semantically related to the characterized keyword includes displaying the semantically related concepts using a tooltip.

7. The search expanding method as recited in claim 6, wherein displaying the tooltip includes adjusting a size of the tooltip according to a relative location of the keyword in the set of documents.

8. The search expanding method as recited in claim 7, wherein adjusting the size of the tooltip includes centering horizontally and vertically the tooltip within a screen.

9. The search expanding method as recited in claim 7, wherein adjusting the size of the tooltip includes defining a scrollable area.

10. The search expanding method as recited in claim 1, wherein the selection of the semantically related concept in the cluster includes clicking on a hyperlink corresponding to the semantically related concept.

11. The search expanding method as recited in claim 1, wherein launching the new search comprises combining the selected semantically related concept with the original query so as to form a new search query.

12. A system for expanding a keyword query search returning a set of documents related to the keyboard query, the search expanding system comprising:
means for characterizing one keyword in the returned set of documents;
means for proposing, for each characterized keyword, a cluster of concepts semantically related thereto;
means for selecting a semantically related concept in the cluster, associated to one keyword; and
means for launching a new search using a query containing at least the selected semantically related concept and at least one keyword as the query, thereby expanding the original keyboard entry search.

13. A system for expanding a keyword query search returning a set of documents related to the keyword entry, the search expanding system comprising:
a processor so configured as to characterize one keyword in the returned set of documents;
a display so configured as to display of a cluster of concepts semantically related to each characterized keyword;
a pointer so configured as to select a semantically related concept in the cluster; and
a query server for launching a new search with a query including at least the selected semantically related concept and at least one keyword, thereby expanding the original keyword query search.

14. The search expanding system as recited in claim 13 further comprising a semantic indexer that indexes and classifies the set of documents into categories of different concepts.

15. The search expanding system as recited in claim 14, wherein the semantic indexer includes a parser and a tokenizer so configured as to respectively parse and tokenize text objects contained in the set of documents.

16. The search expanding system as recited in claim 15, wherein the semantic indexer includes an extractor so configured as to extract precursors from the parsed text objects in the set of documents, the precursors corresponding to the keyword.

17. The search expanding system as recited in claim 16, wherein the semantic indexer is so configured as to link the extracted precursors to corresponding topic-specific taxonomies and ontologies so as to determine concepts semantically related to the extracted precursors, the semantically related concepts forming the cluster.

18. The search expanding system as recited in claim 13, wherein the processor uses highlighting to characterize each keyword in the processed set of documents.

19. The search expanding system as recited in claim 13, wherein the display uses a tooltip to display the cluster of semantically related concepts.

20. The search expanding system as recited in claim 19, wherein the tooltip has an adjustable size.

21. The search expanding system as recited in claim 19, wherein the tooltip includes a scrollable area.

22. The search expanding system as recited in claim 13, wherein the pointer is so configured as to select the semantically related concept by clicking on a hyperlink corresponding to the selected semantically related concept.

23. The search expanding system as recited in claim 13, wherein the query server launches a new search by combining the selected semantically related concept with the original query so as to form a new search query.
